(19) United States
(12) Patent Application Publication
(10) Pub. No.: US 2025/0179596 A1
(43) Pub. Date: Jun. 5, 2025

(54) BIOMASS DIRECT REDUCED IRON

(71) Applicant: TECHNOLOGICAL RESOURCES PTY. LIMITED, Melbourne (AU)

(72) Inventors: Christopher Dodds, Nottingham (GB); Rodney James Dry, City Beach (AU); Samuel Kingman, Nottingham (GB); Jose Rodriguez, Nottingham (GB)

(21) Appl. No.: 18/846,336

(22) PCT Filed: Mar. 9, 2023
(86) PCT No.: PCT/AU2023/050166

§ 371 Date: Sep. 12, 2024

(30) Foreign Application Priority Data
Mar. 12, 2022 (AU) 2022900604

(51) Int. Cl. C21B 13/12; C22B 5/10; C22B 5/12; F27B 9/02; F27B 9/24; F27B 9/36; F27D 11/12; F27D 13/00; H05B 6/70; H05B 6/78; H05B 6/80

(52) U.S. Cl. CPC C21B 13/12; C22B 5/10; C22B 5/12; F27B 9/028; F27B 9/24; F27D 11/12; F27D 13/00; H05B 6/707; H05B 6/78; H05B 6/80; F27B 2009/3607; F27B 2009/3692

(57) ABSTRACT

A method and an apparatus for producing direct reduced iron (DRI) move a material comprising iron ore and biomass through a preheat zone (20) and then a reduction zone (30) of a hearth furnace (3) and heat and progressively reduce iron ore and discharge DRI. Reduction gases flow in an opposite direction to material, and combustible gases in the reduction gases are combusted in the preheat zone and generate heat. Microwave energy heats material and reduces iron ore in the reduction zone. The microwave energy is supplied via a plurality of microwave applicators (66) arranged in a plurality of rows of applicators extending across a width of and along a section of a length of the reduction zone. The reduction zone (56) includes a lower sub zone (58) and an upper sub zone separated by an interface (80). The interface is configured to so that (a) microwave energy is at least substantially prevented from passing through the interface to the upper sub zone and (b) reduction gases produced in the lower sub zone from reduction of iron ore can flow through the interface into the upper sub zone.

### TECHNICAL FIELD

The present invention relates to a method and an apparatus for producing direct reduced iron (DRI) from iron ore and biomass.

The present invention relates particularly, although by no means exclusively, to a method and an apparatus for continuously producing DRI using a hearth furnace having interlinked furnace zones with biomass as a reductant and heat source and microwave energy as a supplemental energy source to facilitate further heating and reduction.

Such DRI, for example while hot, may be subsequently melted in a furnace to create hot metal, then cast as pig iron or refined further to steel in a metallurgical furnace. Alternatively, the hot DRI may be compressed between a pair of rollers with aligning pockets to form a hot briquetted iron (HBI), which can subsequently be supplied to a furnace as a cold charge.

The term “hearth furnace” describes a furnace that includes a lengthwise (whether linear or circular) extending heating chamber and a base that extends along the length of the chamber from an inlet end to a discharge end that carries material through the chamber for rapid thermal processing in the chamber.

The term “direct reduced iron” is understood herein to mean iron produced from the direct reduction of iron ore to iron by a reducing agent at temperatures below the bulk melting temperature of the solids. For the purposes of the discussion herein “direct reduced iron” (DRI) is understood to have at least 85% metallisation.

The term “metallisation” is understood herein to mean the extent of conversion of iron oxide into metallic iron during reduction of the iron oxide, as a percentage of the mass of metallic iron divided by the mass of total iron.

### BACKGROUND

Iron and steel making are historically carbon intensive processes in which the majority of the carbon used is eventually oxidised to CO₂ and discharged to the atmosphere. With the world seeking to reduce overall atmospheric CO₂ there is pressure on iron and steel makers to find means to make iron and steel without causing net emissions of greenhouse gases. In particular, there is pressure not to use coal or natural gas, which are considered non-renewable.

The majority of iron in the world is produced by the blast furnace route, which is a technology that has existed since prior to the industrial revolution. Even with technology advances, the blast furnace currently still requires around 800 kg of metallurgical coal for every tonne of iron produced and emits high levels of CO₂, roughly 1.8-2.0 t CO₂ per tonne of hot metal. The use of fossil fuels, in particular the requirement for coal (in the form of coke), is an essential feed material for a blast furnace to operate, and it is not possible simply to use hydrogen therein as a complete substitute.

An alternative approach to blast furnaces is the direct reduction of iron ore in the solid state by carbon monoxide and hydrogen derived from natural gas or coal. While such plants are (outside of India) minor in number compared to blast furnaces there are many processes for the direct reduction of iron ore. In India coal based rotary kiln furnaces are used to produce DRI, also known as sponge iron (approaching 20% of world production of DRI), while elsewhere they tend to be gas-based shaft furnace processes (approaching 80% of world production of DRI). The gas-based direct reduction plants are usually part of integrated steel mini-mills, located adjacent to an electric arc furnace (EAF) steel plant, but some DRI is shipped from captive direct reduction plants (usually Midrex™ or HYL™ process based) to remote steel mills. Because the DRI is used in electric arc furnaces, there are strict requirements on the levels of impurities in the DRI such as gangue and phosphorus which are expensive and difficult to remove in the EAF. Hence, the iron ores used to make DRI are often crushed and ground to micron particle sizes to enable removal of gangue minerals. Such fine material is difficult to handle (both transport and operationally wise). Therefore, the fine material is agglomerated using water and/or binder to produce closely sized ‘green’ balls which are, once dried, then fed into furnaces where the ‘green’ balls are fired into hard pellets (a process known as induration), before eventually being supplied to direct reduction plants as feed material (or sometimes to blast furnaces as a high quality iron ore feed material to help dilute the gangue of the lump or sinter iron ore that a blast furnace uses). The ‘green’ balls that form the pellets have a typical compressive strength of around 10 N when wet, and 50 N when dried. As pellets (after induration), they have a compressive strength of around 2000 N.

One proposal for an alternative to all of the above is the production of DRI using hydrogen from iron ores (in the form of an indurated pellet feed) followed by smelting in an EAF to produce steel. For this route to be carbon neutral it requires conversion of renewable (green) energy into hydrogen (particularly in periods when wind/solar power cost is low), with subsequent production of DRI using the hydrogen. This route has strong support in Europe and has the potential to become a significant part of the global solution (1). However, there are limitations, as follows.
1. The amount of electricity needed is high (estimated at 3500-4500 kWh/t to the liquid steel stage) and green power costs need to be low (or alternatively a high carbon tax needs to in place) for it to become cost-effective against coal and natural gas-based processes.
2. Hydrogen consumption requirements for the production of DRI are likely to be steady, whilst the generation of hydrogen itself is likely to be periodic in line with the availability of renewable energy, like wind and solar. This calls for a buffering approach to balance supply and demand. Storage and delivery of large amounts of hydrogen however is a technical challenge. Underground salt caverns and exhausted natural gas reservoirs appear to show good potential. However, not all geographical locations may be amenable to this type of hydrogen storage. Moreover, suitable storage locations may not be close to DRI facilities for existing EAF steel mills and/or integrated steelmaking facilities, resulting in supply challenges.
3. Only low-gangue ore types (or those able to readily be upgraded to remove gangue) can be used with the DRI/EAF combination. The EAF will penalise high gangue ore types strongly, rendering them essentially non-competitive. This implies much of the ore currently used in blast furnaces could become sub-economic for such a process route.

It is known that sustainable biomass could be a complementary part of the solution, acting as a substitute for fossil fuels. Burning of either fossil fuels or biomass will release CO₂ when used, however when fast growing plants are the source of the biomass, they are largely a carbon-neutral energy source (since through photosynthesis around the same amount of CO₂ is taken up when the plants are regrown).

To date there is no large-scale commercial ironmaking process that uses biomass directly, including for the DRI production route. Previous attempts to insert some biomass into processes originally designed for coal (e.g., blast furnaces and coke ovens) are marginal at best, typically relying on a pre-charring step for the biomass and usually quite disappointing in terms of overall CO₂ impact. This is largely because the nature of biomass is vastly different to that of coal. To use biomass successfully it is necessary to re-design the process around the fundamental nature of biomass.

Biomass can take many forms and avoiding competition with food production is key for biomass selection. Examples of biomass that might meet the selection criteria include elephant grass, sugar cane bagasse, forestry by-products, excess straw, azolla and seaweed/macroalgae. Such biomass availability varies considerably from one geographic location to another—and will most likely be a significant factor in determining the size and location of future biomass-based iron plants given the volume of material required and the economic challenges in transporting such material long distances.

Biomass, such as wood chips, has been shown in lab-scale studies (2) to be able to reduce iron ore to solid iron by the intermingling thereof with iron ore and placing in a furnace that heats the ore up to over 800° C. within a controlled atmosphere that prevents re-oxidation of the reduced material. While intermingling assists with the efficacy of the reduction process, on an industrial scale as a continuous process it potentially creates challenges, where gas flow created by convection heating as part of the reduction process picks up fine particles of char, leading to massive gas processing/char recycling challenges, or a lot of carbon being wasted through the need to clean up the off-gases from the process, before discharge to the atmosphere.

Another example (described from laboratory phase experiments) is disclosed in AU 2007227635 B2 in the name of Michigan Technological University. The patent discloses the use of briquettes (for example, in the shape of coherent spherical balls) produced by mixing iron ore concentrate comprising magnetite (Fe₃O₄), wood chips that have passed through a 4.75 mm sieve, a small amount of flour, and slight moistening (to achieve agglomeration). The patent discloses that the composites were dried at 105° C. (to provide strength and rigidity) in handling. The composites were then placed in a furnace (that was electrically heated) at temperatures in excess of 1375° C. to undertake the reduction of the iron ore. The patent discloses that preferably fine iron ore particles should be used and that while ‘particles as large as 0.25 inch in diameter’ (i.e., the typical top size of iron ore fines, being 6.35 mm) ‘or larger could be used, processing times would be unnecessarily long, and particles would not lend themselves to being formed into a coherent mass’.

The application of electromagnetic energy, such as microwave (MW) energy and radio frequency (RF) energy in iron ore reduction processes, whether as simply a form of heating energy or as a means to enhance reaction rates or provide additional heating at crucial times in the reaction process, to produce DRI has also been considered. One of the first laboratory attempts known to the applicant is described in U.S. Pat. No. 4,906,290 assigned to Wollongong Uniadvice Limited. The patent discloses that briquettes containing a mixture of iron ore fines, coal and burnt lime were subjected to microwaves until they glowed red and were then placed in a crucible where they were smelted to produce a molten iron containing 3.8% carbon. While no examination of the microwave product from the microwaving is disclosed in the patent, it is likely that DRI was produced.

Another attempt in a laboratory where both MW energy and/or RF energy was applied to iron ore reduction is set out in US 2009/0324440 A1 assigned to Anglo Operations Limited. Although perhaps more focussed on ways to process titaniferous (i.e., ilmenite) type material, which would first be pre-oxidised to enhance reactivity (by the burning of any available fuel, including biomass, in an oxygen rich environment to facilitate such oxidation), it does disclose the reduction of hematite type iron ore in a fluidised bed reactor under atmospheres of solely H₂ (at temperatures between 400° C. and 600° C.) or CO (at temperatures between 600° C. and 800° C.) with or without the presence of MW energy or RF energy. The tests with such energy showed enhanced reaction rates, without any significant additional heating from the application of such energy. The tests appear to be confined to domestic MW work.

Another attempt (also laboratory based) to enhance reaction rates or provide additional heating at crucial times in the reaction process, to produce DRI is described in International application PCT/AU2017/051163A in the name of the applicant. That application describes an invention of a process and an apparatus for direct reduction of iron ore in a solid state wherein briquettes of iron ore fragments and biomass are passed through a preheating chamber where they reach at least 400° C. before entering a heating/reduction chamber that is under anoxic conditions with biomass as a reductant and with electromagnetic energy as a source of energy.

Thus, various lab-scale studies have shown that iron ores mixed with biomass and heated in a small furnace can produce DRI in a manner that appears (superficially) somewhat better than that expected from first principles. Likewise, the use of electromagnetic energy in such iron ore reduction processes has been shown to be advantageous. The technical challenge remains how to perform this efficiently at large scale, particularly where electromagnetic compatibility (EMC) requirements impose stringent limits on any emissions outside the internationally agreed and recognised bands for the application of MW energy and RF energy. These limits are much lower than those imposed by health and safety and are typically equivalent to μWs of power at any frequency outside the allowed bands.

One attempt to set out how such a reduction process for direct reduction of iron ore in a solid state under anoxic conditions with biomass as a reductant and with electromagnetic energy as a source of energy might operate at scale is described in Australian provisional application 20200904332 in the name of the applicant. That application describes an invention of a process and an apparatus for direct reduction of iron ore in a solid state under anoxic conditions with biomass as a reductant and with electromagnetic energy as a source of energy where gases arising from reduction of the ore from that occurrence point (reduction zone) flow into an oxygen available combustion zone where the iron ore may be initially heated from such combustion (preheat zone), while still maintaining anoxic conditions in the reduction zone. This approach is colloquially described as ‘Countercurrent’ as briquettes (of a composite of iron ore fragments and biomass) travel in one direction and the off-gases from reduction therein travels in the opposite direction. The disclosure in the application is incorporated herein by cross-reference.

The applicant has carried out further development work into the invention described in the above application to better establish how to perform the invention at scale in an efficient manner.

It is understood that the above description is not to be taken as an admission of the common general knowledge in Australia or elsewhere.

### SUMMARY OF THE DISCLOSURE

In broad terms, the present invention provides a method and an apparatus for producing direct reduced iron (DRI) move a material comprising iron ore and biomass through a preheat zone and then a reduction zone of a hearth furnace and heat and progressively reduce iron ore and discharge DRI. Reduction gases flow in an opposite direction to material, and combustible gases in the reduction gases are combusted in the preheat zone and generate heat. Microwave energy heats material and reduces iron ore in the reduction zone. The microwave energy is supplied via a plurality of microwave applicators arranged in a plurality of rows of applicators extending across a width of and along a section of a length of the reduction zone. The reduction zone includes a lower sub zone and an upper sub zone separated by an interface. The interface is configured to so that (a) microwave energy is at least substantially prevented from passing through the interface to the upper sub zone and (b) reduction gases produced in the lower sub zone from reduction of iron ore can flow through the interface into the upper sub zone.

The present invention is based on a realisation that consideration of a number of potentially conflicting demands is required when seeking to have an effective and efficient method for producing direct reduced iron (DRI) from iron-containing material, such as iron ore, using biomass (as a source of reductant) and electromagnetic energy in the form of microwave energy (as a further heating source) in a hearth furnace, as described herein, in which there is a conveyor transporting a bed of iron-containing material such as iron ore, typically at least initially in the form of briquettes of iron ore and biomass, from an inlet (typically, initially as a briquette feed) end to an outlet (DRI discharge) end, where combustible gases arising from heating biomass and reduction of iron ore are combusted by air or oxygen-enriched air fed burners in one zone of the furnace (a “preheat zone”) and where microwave energy is supplied within an anoxic atmosphere zone of the furnace (a “reduction zone”), with gases generated in the reduction zone flowing into the preheat zone, counter to the direction of movement of iron-containing material.

One conflicting demand is for microwave energy within the reduction zone to be delivered in a well-defined energy pattern towards a top surface of the conveyor with a view to providing uniform heating across and along the bed of iron-containing material such as iron ore. The applicant has realised that this demand can potentially be accommodated using a plurality of microwave horns (described further below) or other suitable applicators placed in close proximity to a moving bed of iron-containing material, with the horns (or other suitable applicators) being arranged to form a regular field pattern. The horns may be arranged, for example, in a co-polarisation (same orientation) manner. Alternatively, some horns may be arranged in the same orientation and others may be rotated through 90 degrees to create homogeneity through overlapping of multiple field patterns.

Another conflicting demand is for gases arising from reduction reactions within the bed of iron-containing material in the reduction zone to be not constrained in a way that results in (a) the gas velocity of such gases that pass into the preheat zone exceeding a velocity where there is significant entrainment of material (i.e. dust make) from the reduction zone into the preheat zone and/or (b) significant entrainment of material back into the preheat zone as the bed of iron containing material moves from the preheat zone into the reduction zone. Item (b) can arise if the apparatus creates a wind tunnel above the bed in a region of the end of the preheat zone and the beginning of the reduction zone that entrains fine material and blows it back into the preheat zone. On the face of it, this demand is difficult to accommodate where there is an array of microwave horns in the reduction zone in close proximity to the moving bed of iron-containing material. The applicant has realised that this demand can be accommodated by configuring the plurality of microwave horns or other suitable applicators so that they are not a barrier to free movement of gases that are released from reduction reactions, leading to localised regions of high gas velocity.

Generally, microwave systems/apparatus for heating can be described as comprising three component parts being a generator (with associated power supply), a transmission system (which typically includes a waveguide or a coaxial line and devices for tuning/impedance matching, etc.), and an applicator. The generator produces microwaves through use of a magnetron or the like at a set frequency and the transmission system receives the microwaves and transports them in a contained manner to the applicator. The waveguide is formed from electrically conductive material or is surrounded by electrically conductive material. For example, the waveguide may be made of metal with a high conductivity such as copper, aluminium, brass, steel and sometimes has a conductive coating. The applicator is the structure, such as a horn, which applies the microwave energy to the material to be heated within a resonant cavity. The term “applicator” is understood herein to have this meaning, noting that applicator can have different meanings in the field of the invention. It is known that simply applying microwaves in such a cavity does not of itself produce uniform heating. In domestic microwaves for example this is addressed by moving the material around on a rotating platform. On a larger industrial scale, material for heating can be placed on a belt which is moved through the cavity. Typically, the microwave applicator in such situations supplies microwaves to a multi-modal cavity in which the microwaves bounce around heating material that passes through from all directions. An example of a multi-modal cavity can be seen in the figures for International patent application PCT/AU87/00167 in the name of Neartic Research Centre (Australia) Pty Limited. The standing wave pattern created in such cavities by destructive and constructive interference oscillates any dielectric material that passes through it at the frequency of the generator. The dissipation of energy from such oscillation (dielectric loss) occurs in the form of heat.

Traditionally, microwave horns and other suitable applicators are located at an end of a waveguide. For horns, their use is mostly in antenna/receiver situations (rather than typically in heating situations) where they are used either to transmit microwaves from a waveguide into a space in a directional manner or to collect microwaves into a waveguide when acting as a “receiver”. Typically, a horn is a flared metal waveguide, i.e. shaped like a horn. Typically, a horn comprises side walls that define the horn. In some instances, at least some of the walls diverge outwardly with distance from an end of a waveguide so that the transverse diameter of the horn increases towards an outlet opening. In other instances, walls neither diverge or converge. Without such a horn, the typically small aperture of a waveguide (typically less than one wavelength) causes significant diffraction of the waves issuing from it, resulting in a wide radiation pattern without much directionality. Further, if a simple open-ended waveguide is used as an antenna, without a horn, the sudden end of the conductive walls causes an abrupt impedance change at the aperture, with the impedance step causing a waste of energy through a significant amount of energy being reflected back down the waveguide.

The applicant has also realised that, while there is a need to deliver as much microwave energy as possible directly to material passing through the reduction zone to maximise the effectiveness of such application, it must be done in a way that meets a plurality of metrics. In this context, a key objective is to heat a maximum area relatively uniformly, without having fields spreading too far so that applicators such as horns interact with each other. This requires balancing competing metrics.

One metric is referred to as the Power intensity (P_{INT}), which is the average power dissipated in a mass of a bed of material within the reduction zone of the furnace. The applicant, through experimental batch tests undertaken on its behalf, has found that up to 5 kW/kg of material is a required microwave intensity for producing DRI with high metallisation. In a continuous process, it is speculated that this intensity might be between 1 to 10 kW/kg of material, typically 3 to 5 kW/kg of material. In fact, the applicant has determined that, because of such energy requirements, a hearth furnace could have as many generators as there are horns.

Another metric is referred to as the Power Uniformity Index (PUI), which is a measure of power dissipation variation across a bed of an iron-containing material, noting it is desirable that that power dissipation variation across a bed be as low as possible, with zero being perfect. In experimental batch tests an index of less than 0.7 has been observed.

A third metric is Cross-Coupling, which is a measure of the amount of power in the form of microwaves that are reflected back towards a different generator to the one from which they originated. The applicant has set a target for this metric of less than 1% when applying the invention.

A fourth metric is Reflection, which is a measure of the amount of power in the form of microwaves that are reflected back from the generator from which they originated. The applicant has set a target for this metric of less than 10% when applying the invention.

The invention provides a method for producing direct reduced iron (DRI), typically continuously, from iron ore using biomass (as a source of reductant) and microwave energy (as a heat source) in a furnace, such as a hearth furnace, having a preheat zone and a reduction zone, the method including moving a conveyor carrying a material, the material including iron ore and biomass, and the material typically at least initially being in the form of briquettes of iron ore and biomass, successively through the preheat zone and the reduction zone in a direction from an inlet to an outlet and heating and progressively reducing iron ore and discharging DRI from the outlet, allowing reduction gases including combustible gases produced by heating material and by reduction of iron ore to flow in an opposite direction to that of the conveyor, i.e. towards the preheat zone, combusting combustible gases in the reduction gases via air or oxygen-enriched air fed burners in the preheat zone, maintaining an anoxic atmosphere in the reduction zone, supplying microwave energy to facilitate heating and reduction of iron ore in the anoxic atmosphere in the reduction zone, with the microwave energy being delivered directly onto material on the conveyor via a plurality of microwave applicators, such as horns, having microwave outlets in a chamber of the reduction zone, with the applicators being arranged in a plurality of rows of applicators extending across a width of and along a section of a length of the reduction zone with the microwave outlets being spaced above but in close proximity to the material on the conveyor, with the reduction zone including a lower sub zone and an upper sub zone separated by an interface, with the interface being configured so that (a) microwave energy is at least substantially prevented from passing through the interface to the upper sub zone and (b) reduction gases produced in the lower sub zone can flow through the interface into the upper sub zone.

The term “interface” is understood to be a transition between the lower sub zone and the upper sub zone of the reduction zone.

The interface may be a sharp transition between the two sub zones.

The invention is not confined to a sharp transition and the transition may be more gradual over a section of the height of the reduction zone, having regard to the purpose of the interface being to (a) prevent microwave energy passing through the interface to the upper sub zone and (b) allow reduction gases produced in the lower sub zone flowing through the interface into the upper sub zone.

It is noted that creating a positive flow of reduction gases from the lower sub zone to the upper sub zone will restrict reduction gases being able to return to the lower sub zone.

Typically, the interface is above outlet openings of the applicators.

There are many different design possibilities for the interface between the two sub zones.

For example, the interface may include the applicators.

The applicators may be horns.

The horns may be perforated horns, with perforations that are configured to allow reduction gases and at least substantially no microwave energy to pass therethrough.

The term “perforated horns” is understood herein to mean horns that are defined by side walls, typically formed from sheet material, that have a plurality of perforations, for example in the form of holes or slots, punched/cut through the side walls. The arrangement and the size of the perforations typically will in part be determined by the wavelength of the microwave energy and the thickness and the materials selection of the side walls of the horns. The perforations design may be any size and/or shape but must be selected to prevent microwaves from passing through the perforations while not unduly restricting reaction gases passing therethrough. An example of where perforations are currently used in a microwave system is for the typical door of the domestic microwave oven. There, such perforations, while behind glass which bars gas flow, provide a safe viewing window into the microwave oven.

The applicators may be suspended from an upper section, such as a roof, of the reduction zone.

The applicators in each row and in successive rows of applicators along the length of the section of the reduction zone may be in contact with each other so that the interface is a continuous interface formed by the applicators.

The rows of applicators may be spaced apart along the length of the section of the length of the reduction zone so that there are gaps between successive rows.

At least some of the applicators in at least some of the rows may be spaced apart so that there are gaps between the applicators.

Alternatively, or in combination therewith, when the applicators are spaced apart in the rows and/or between the rows, the interface may include a microwave energy barrier in gaps between the applicators that is configured to allow reduction gases to pass therethrough and to at least substantially prevent microwave energy passing therethrough passing through so that the interface is a continuous interface between the sub zones.

The microwave energy barrier may include a plurality of tubes that fill gaps between the applicators, with the tubes being selected to be a size and depth to prevent microwaves from passing therethrough.

The microwave energy barrier may include a perforated element, such as a perforated plate, that forms a skirt that fills gaps between the applicators.

The applicators of at least some of the rows may be offset laterally relative to the applicators of at least some of the other rows—i.e. laterally relative to the direction of movement of material through the reduction zone.

More particularly the applicators of each row may be offset with respect to the applicators of successive rows.

The method may include supplying microwave energy to each applicator so as to deliver microwave energy to form a well-defined field pattern, such as a hotspot on material on the conveyor.

The method may include supplying microwave energy to the plurality of rows of applicators to create a uniform, typically highly uniform, regular heating pattern for material on the conveyor in the reduction zone.

The average difference in height of each applicator above the height of material on the conveyor may be selected to be sufficiently small so that there is a highly resonant and well-defined field pattern which maximises absorption and homogeneity across a defined area and minimises cross coupling of microwave energy (as per the metrics detailed above).

The applicators may be spaced apart from each other (both within the rows and between rows) so that there is no significant cross-coupling of microwave energy.

When the applicators are horns, the horns may be any suitable design, such as pyramidal or conical, and any suitable length.

In one embodiment, focussed on efficiency of microwave delivery to create a uniform, typically highly uniform, regular heating pattern, the horns are pyramidal horns.

The pyramidal horns may be sectorial horns, each with one pair of opposing sides being flared and the other pair of opposing sides being parallel.

Typically, the sectorial horns produce fan-shaped beams, which are narrow in the plane of the flared sides, but wider in the plane of the narrow sides.

The flaring may be in the E-plane (electric field) or H-plane (magnetic field) direction so that the microwave outlet is a rectangular-shaped opening.

The sectoral horns in each row may be placed across the conveyor so that the shorter sides of rectangular microwave outlets of the sectoral horns are parallel with the direction of moment of the conveyor within the reduction furnace.

Without limiting the design options, the microwave energy barrier may be in the form of perforated metal elements (described below as skirts) that are connected to the horns close to the microwave outlets of the horns (with the arrangement being described below as skirted horns) to, in effect, form a single continuous perforated interface at this height of the reduction zone to further at least substantially confine the microwaves to the lower sub zone of the reduction zone.

For the avoidance of doubt, the use of such skirted horns does not preclude the providing two distinct reaction gas paths, one above and the other below the skirt, ensuring gas flow is sufficiently unrestrained so as not to create excessive gas velocity between the two furnace zones that significantly entrains material passing there through.

A further design feature may be to selectively perforate the horns, for example so that upper halves of the horns are not perforated. This may aid in ensuring that reaction gases do not readily pass up the horns into the linked waveguides and transmission systems generally.

The method may include generating a higher pressure in upper sections, for example upper halves of the horns by supplying an inert gas, such as nitrogen, or any other suitable gas into the upper sections of the horns to discourage reaction gases passing up the horns into the linked waveguides and transmissions systems generally, noting that such gas injection must also contribute to creating and maintaining the anoxic environment.

In any given scenario, the selection of the size and shape of perforations in the horns will be a function of factors including microwave energy wavelength, perforation shape and characteristics of the material of the horns. The typical shielding effectiveness (SE) of a metal perforated metal plate depends on the wavelength, perforation size (such as hole diameter), and plate thickness. For example, to ensure a negligible leakage (SE>60 dB, ˜99.9999% containment) through a metal plate at 915 MHz, plates with a thickness of 3 mm, 5 mm, and 10 mm, would require holes (where holes are selected for the perforations) smaller than 3 mm, 4.5 mm, and 8 mm respectively. If wider holes are required, then tubes could be used in which case for example a 100 mm diameter tube would need to be 220 mm long in order to provide the same level of confinement.

The term “heath furnace” is understood herein to mean a furnace that is circular or linear in nature and of a generally horizontal disposition that is refractory lined, through which some form of conveyor passes, with the conveyor eventually returning to its conceptual starting point and upon which, while passing through the furnace, briquettes can reside, and in which gases from the heating of such briquettes and reduction of the iron ore within are substantially contained before passing from the furnace for eventual discharge as flue gases.

It is noted that the invention extends to embodiments in which a feed material is initially in the form of a briquette and the briquettes break down as they move through a hearth furnace and form fragments.

The use of the term “discharge as flue gases” does not exclude further use(s) and/or combustion of any combustible residual gases so that residual heat energy from the gases can be utilized or recovered before the gases are finally discharged to the atmosphere. The use of the term “furnace” does not preclude the use of distinct interlinked furnaces, such as where one is acting as the preheating zone and another as the reduction zone, the requirement being however that the flow of materials and gases be maintained as described.

The term “conveyor” is understood herein to mean any apparatus that forms a moving surface upon which briquettes (or fragments formed when briquettes break down) may reside in essentially a static position (on such surface) while passing through the furnace and being reduced, but is not to be limited to any particular form of moving base, the only requirement being that it passes in a circuit which has each part of the base eventually returning to its conceptual starting point (with the same orientation).

Without in any way limiting, and as examples only, such base may be in the case of a linear heath furnace be:
a) a plurality of individual trays or plates (whether of metal, refractory material or a blend of both);
b) a linked segmented high temperature resistant metal belt, or
c) a single unbroken metal belt formed from joining up a strip(s) or elongated sheet(s) of suitable high temperature resistance metal,
   that while passing through the furnace (or a significant portion thereof) form a contiguous elongated generally linear base on which briquettes can reside.

The term “anoxic” is understood herein to mean substantially or totally deficient in oxygen.

The term “briquette”, as originally fed into the hearth furnace, is understood herein as a broad term that means a composite of iron ore fragments and biomass that has formed as a result of the iron ore fragments and biomass being brought into close contact through compaction, or alternatively through mixing and binding together, of the iron ore and biomass. Those skilled in the art would typically describe the latter (particularly when in a spherical form) as pellets. While the inventors believe “green” pellets have some inherent challenges, not least being they usually need to be carefully dried first (thereby avoiding any sudden steam evolution) and any chosen binder used cannot be one where massive instantaneous devolatilization occurs during heating—both events potentially leading to structural failure of the pellet; pellets are not excluded, but the term briquette does not include indurated pellets, as a feed material according to the method, as such pellets basically get their increased compressive strength by oxidation of the iron ore fragments at temperature back to a higher state of oxidation and through sintering with at least some cross bonding between such fragments. As such they cannot contain biomass (at least not in a uncarbonized form, i.e., any residual carbon remaining could only be there simply as a function of oxidation reactions not being provided with sufficient time to reach equilibrium).

It will be understood that the composition, size, shape and/or integrity of briquettes will vary as they are processed through the hearth furnace to eventually exit as DRI. The briquettes may lose structural integrity and not be in a form that resembles the feed briquettes. The use of the term “briquette” when describing the passage of material through various zones of the furnace is not intended to be self-limiting to what was originally fed into the hearth furnace but is used merely for descriptive convenience.

The term “fragment” is understood herein to mean any suitable size piece of iron ore (as passed through an appropriately screen mesh of 6.35 mm spacing or below) and as used herein may be understood by some persons skilled in the art to be better described as “particles” and/or “fines”. The intention herein is that such terms be used as synonyms. The iron ore may be any suitable type such as magnetite, hematite and/or goethite. However, it does not preclude other iron rich ores from which iron may be extracted such as limonitic laterites, titaniferous magnetite and vanadiferous magnetite due to the local unavailability of the more usual forms of iron ore from which iron is traditionally extracted.

The term “biomass” is understood herein to mean living or recently living organic matter. Specific biomass products for a composite of iron ore fragments and biomass include, by way of example, forestry products and their by-products (in the form of woodchips, sawdust and residues therefrom), agricultural products and their by-products (like sorghum, hay, straw and sugar cane bagasse), agricultural residues (like almond hull and nut shells), purpose grown energy crops such as Miscanthus Giganteus and switchgrass, macro and micro algae produced in an aquatic environment, as well as recovered municipal wood and paper wastes.

To achieve the desired removal of the majority of volatiles from the biomass within heated briquettes prior to briquettes leaving the preheat zone, the finish preheat temperature for the briquettes (as a collective as they leave the preheat zone, i.e., bulk temperature) may be in a range of 600 to 800° C., and more typically at least 700° C. to 800° C. Because of the nature of a bed of briquettes, the temperature throughout the bed (at least in the preheat zone) will not be uniform and will definitely vary through the bed and may also vary across the bed.

Volatiles is usually understood in respect to carbonaceous material to mean gases, other than those arising from water (whether bound or free) being initially driven off, that are formed or released by heating of the carbonaceous material to cause breakdown of organic components therein to gases or liquids.

Unlike the position with coal, the inventors are not aware of an industry standard for measuring volatiles in biomass. For coal, volatiles (volatile matter) is measured as a weight percentage of gas (emissions) from the coal sample that is released during heating to, typically, 950° C. in an oxygen free environment, except for moisture (which will evaporate as water vapour) at a determined standardization temperature. The inventors believe that it is desirable generally for low-boiling-point organic compounds that will condense into oils on cooling to not be present in the residual biomass that passes into the reduction zone, where such compounds have the potential to interfere and/or interact with the microwave system.

Accordingly, the term “volatiles” is understood herein to mean only low-boiling-point organic compounds that are driven off at temperatures below 600° C. upon heating in an oxygen free environment.

Typically, the method includes supplying briquettes at ambient temperature to the preheat zone of the furnace and progressively heating briquettes to a finish preheat temperature as briquettes are transported through the preheat zone on the conveyor.

The method may include controlling the method so that at least 90%, typically at least 95%, of volatiles in biomass in the briquettes is released as a gas in the preheat zone.

The control options for achieving volatilisation mentioned in the preceding paragraph include controlling, by way of example, any one or more than one of the temperature profile in the furnace, the residence time of briquettes in the preheat zone, the length of the preheat zone, the travelling speed of the conveyor, the briquette loading on the conveyor, and the amount of biomass in the briquettes, noting that a number of the factors are inter-related.

By way of example, the travelling speed i.e., velocity, of the conveyor may be controlled so as to give briquettes sufficient time in the preheat zone for at least 90%, typically at least 95%, of the volatiles to be released from biomass in briquettes.

The travelling speed may also be controlled so that heating briquettes in the reduction zone using microwave energy alone increases the temperature of briquettes by at least a further 150° C., and preferably at least 250° C.

It is noted that travelling speed is not the only factor relevant to achieving the at least 150° C. temperature increase of briquettes in the reduction zone. Other factors include controlling, by way of example, any one or more than one of the residence time of briquettes in the reduction zone, the length of the reduction zone, the briquette loading on the conveyor, the type and power of the microwave energy, noting that a number of the factors are inter-related.

The briquettes, as originally fed into the hearth furnace, may be any suitable size and shape.

By way of example, the briquettes may have a volume of less than 25 cm³ and greater than 2 cm³. Typically, the briquettes may have a volume of 3-20 cm³.

By way of example, the briquettes may have a major dimension of 1-10 cm, typically 2-6 cm and more typically 2-4 cm.

By way of example, the briquettes may be generally cuboid, i.e., box-shaped, with six sides and all angles between sides being right angles. By way of example, the briquettes may be “pillow-shaped” briquettes. By way of further example, the briquettes may be “ice hockey puck-shaped” briquettes.

The briquettes, as originally fed into the hearth furnace, may include any suitable relative amounts of iron ore and biomass. The briquettes may include 20-45% by weight on a wet (as-charged) basis, typically 30-45% by weight on a wet (as-charged) basis, of biomass. When choosing to use compacted briquettes ideally the biomass chosen has a significant lignocellulosic component within.

In any given situation, the preferred proportions of the iron ore fragments and biomass will depend on a range of factors, including but not limited to the type ore (e.g. hematite, goethite or magnetite) and their particular characteristics (such as fragment size and mineralogy), the type and characteristics of the biomass, the operating process constraints, and materials handling considerations.

The DRI on exiting the reduction zone may be at a temperature of at least 900° C., typically at least 1000° C., from the further heating by microwave energy.

Preferably, the DRI on exiting the reduction zone has a temperature in a range of 1000 to 1050° C.

The use of the term ‘reduction zone’ does not preclude all or the majority of the iron ore reduction occurring in that zone. Likewise, the use the use of the term ‘preheat zone’ does not of itself preclude some reduction of iron ore actually occurring therein.

The method may include generating a higher pressure of gases in the reduction zone compared to gas pressure in the preheat zone and thereby causing gases generated in the reduction zone to flow counter-current to the direction of movement of briquettes on the conveyor through the furnace.

The method may include creating higher pressure in the reduction zone by means of a gas flow “choke” between the reduction zone and the preheat zone of the furnace.

The gas flow “choke” in the reduction zone may be configured so as to increase the flow rate of gases generated from the reduction zone to the preheat zone by a factor of 2-3 compared to what the flow rate would have been without the gas flow “choke” in order to ensure that there is no substantial gas flow from the preheat zone to the reduction zone of the furnace.

The microwave energy may have any suitable microwave frequency, but the current industrial frequencies of around 2450 MHz, 915 MHz, 922 MHz, 896 MHZ and 433 MHz are of most interest. For example, in Australia and South Africa 922 MHz is the allocated frequency. In USA and Europe, 915 MHz is the allocated frequency. In UK, 896 MHZ is the allocated frequency. A key requirement however is that the furnace be designed so that the energy is contained within the furnace.

As noted above, the briquette heating in step (b) may include generating heat by burning combustible gases generated in the furnace via the plurality of air or oxygen enriched air fed top space burners, typically preheated air or oxygen enriched air fed top space burners, within the preheat zone.

Typically, step (b) includes combusting at least 90% by volume, more typically at least 95%, of combustible gases generated in the furnace.

The burners may be either (i) spaced along the top of the oven chamber or (ii) aligned more or less horizontally along the long axis to assist in ensuring a generally uniform heating pattern along the length of the preheat zone and to achieve direct radiant heat transfer from the top of the chamber.

The amount of preheated air or oxygen enriched air fed to each burner may be adjusted to compensate for established variations in fuel gas flow across and along the chamber.

In use, combustible gases in the hot gas flowing into the preheat zone from the reduction zone combust as the gases passes each of the plurality of air or oxygen enriched air fed top space burners.

The combustion profile, i.e., the profile of post-combustion of combustible gas along the length of the preheat zone, may be 35-45% at a hot end of the preheat zone, i.e., at the end adjacent the reduction zone, increasing to 90-95% at a cold end of the preheat zone, i.e., at the end adjacent the feed zone. The combustion profile may be any suitable profile.

Post combustion (PC) is defined herein as:

$$PC \% = 100 \times ( {CO}_{2} + {H}_{2} O ) / ( CO + {CO}_{2} + {H}_{2} + {H}_{2} O ) ,$$

where the symbol for each species (CO, CO₂ etc) represents the molar concentration (or partial pressure) of that particular species in the gas phase.

In simple terms, PC is a measure of the combustion of combustible gas, with zero indicating no combustion and 100% indicating fully combusted.

It follows from the preceding paragraphs that the above combustion profile maintains the preheat zone top space in a bulk reducing condition along the length of the preheat zone, with feed oxygen being consumed rapidly in the vicinity of each burner (in a small localised region).

The method may include discharging gas produced in the furnace by heating and/or combustion within the furnace as a flue gas through a flue gas outlet in the feed zone.

The method may include processing the flue gas in a flue gas system before discharging the processed flue gas to the atmosphere.

The method may include recovering heat from the flue gas and using the heat for preheating air to the burners in the preheat zone.

By way of example, gas discharged from the preheat zone via the flue gas outlet is typically ducted (hot, around 1100-1300° C.) to an afterburning chamber where there is final combustion of combustible gas in the flue gas and consequential heat generation.

The method may include discharging DRI from the discharge zone via the outlet into a vessel that is configured to restrict substantial ingress of oxygen-containing gases into the vessel. Positive nitrogen gas streams can be used to assist in this process.

Where the vessel is in part a container, that is exchanged on filling with a replacement container, it is preferred that such container remain sealed after filling. Without steps being taken to control the amount of oxygen available to the DRI, the oxygen will rapidly re-oxidise DRI and may become partially liquid.

One example of a vessel is a vessel that has (a) an opening to receive hot DRI, (b) forms an integral seal with the outlet of the furnace at least during filling the vessel, and (c) a closure that can close that opening after receiving the hot DRI. It is not necessary that the closure forms an absolutely gas-tight seal with the vessel, only that the closure be sufficient that it is sealed enough to restrict ingress of air that causes unacceptable levels of oxidation of DRI. The skilled person will understand the requirements for the gas-tight seal. Positive nitrogen gas streams can be used to limit access of air into the vessel.

The present invention also provides a method for producing direct reduced iron (DRI), typically continuously, from iron ore using biomass (as a source of reductant) and microwave energy (as a heat source) in a hearth furnace, the method including counter-current movement of (a) a material, the material including iron ore and biomass, and the material typically at least initially being in the form of briquettes of iron ore and biomass, successively through a preheat zone and a reduction zone in a direction from an inlet (the inlet end) to an outlet (the outlet end) and discharging DRI from the outlet and (b) a flow of combustible gases produced by heating material and reduction of iron ore in material in the reduction zone to the preheat zone (at the inlet end), combusting combustible gases arising from heating of biomass and reduction of iron ore by air or oxygen-enriched air fed burners in the preheat zone, maintaining an anoxic atmosphere in the reduction chamber, supplying microwave energy to facilitate reduction of iron-containing material in the anoxic atmosphere, with the microwave energy being delivered via a plurality of microwave horns into a lower sub zone of the reduction zone directly onto the bed of iron containing material below the horns, with the horns having perforations that enable reduction gases arising from such reduction to pass therethrough while at least substantially preventing microwave energy from passing therethrough, thereby allowing the reduction gases to be sufficiently unrestricted by the horns so that reduction gases can flow into an upper sub zone of the reduction zone so that reduction gas flowing from the reduction zone to the preheat zone does not exceed a threshold bulk gas velocity.

The threshold bulk gas velocity may be any suitable velocity having regard to factors such as the material being processed and the size and shape and other structural characteristics of the hearth furnace.

The threshold bulk gas velocity may be 5 m/sec.

For the avoidance of doubt, the gas velocity at the interface between the preheat zone and the reduction zone may be greater than 5 m/sec in embodiments where it is desirable to ensure that there is no inadvertent entrainment of gases from the preheat zone.

The invention also provides an apparatus for producing direct reduced iron (DRI), typically in a continuous manner, from iron ore and biomass, typically at least initially in the form of briquettes of a composite of iron ore fragments and biomass, the apparatus including a furnace that includes a chamber having:
(a) an inlet for a material, the material including iron ore and biomass, the material typically at least initially being in the form of briquettes of iron ore fragments and biomass, at one end and an outlet for direct reduced iron at the other end,
(b) the following zones:
   (i) a feed zone that includes the inlet,
   (ii) a preheat zone for heating the material and reducing iron ore in the material and releasing volatiles in biomass in the material, the preheat zones including a plurality of air or oxygen-enriched air fed burners for generating heat by burning combustible gases in a top space of the preheat zone, with the combustible gases including combustible gases originating within the furnace,
   (iii) a reduction zone for heating the material and reducing iron ore in the material and forming DRI, the reduction zone including an upper sub zone and a lower sub zone and an interface separating the sub zones that is configured to so that (a) microwave energy is at least substantially prevented from passing through the interface to the upper sub zone, (b) reduction gases produced in the lower sub zone from reduction of iron ore can flow through the interface into the upper sub zone, a plurality of applicators such as horns arranged in rows across a width of and along a section of a length of the reduction zone for supplying microwave energy into the lower sub zone for heating material in the lower sub zone, the applicators having microwave outlets for microwave energy, at least substantially all of the applicators in each row configured so that microwave energy forms a regular field pattern; and
   (iv) a discharge zone that includes the outlet; and
(c) a conveyor for receiving and transporting the material through the zones from the inlet to the outlet.

The applicators may be arranged in a co-polarisation (same orientation) configuration.

It is noted that in other embodiments not all of the applicators are arranged in the co-polarisation (same orientation) configuration. For example, some applicators may be arranged in the same orientation and others may be rotated through 90 degrees to create homogeneity through overlapping of multiple field patterns.

In some embodiments, some horns may have longer faces parallel to the travel direction of material.

The interface may be a sharp transition between the two sub zones.

The interface may be a gradual change over a section of the height of the reduction zone.

The interface may include the applicators.

The applicators may be horns.

The horns may be perforated horns, with perforations being configured to allow reduction gases and at least substantially no microwave energy to pass therethrough.

The horns applicators in each row and in successive rows of horns applicators along the length of the section of the reduction zone may be in contact with each other so that the interface is a continuous interface between the sub zones.

At least some of the rows of applicators may be spaced apart along the length of the section of the length of the reduction zone so that there are gaps between the successive rows.

The horns applicators in at least some of the rows may be spaced apart so that there are gaps between the applicators.

The interface may include a microwave energy barrier in gaps between the applicators that is configured to allow reduction gases to pass therethrough and to at least substantially prevent microwave energy passing therethrough.

The microwave energy barrier may include a plurality of tubes that fill gaps between the applicators, with the tubes being selected to be a size and depth to prevent microwaves from passing therethrough.

The microwave energy barrier may include a perforated element, such as a perforated plate, that forms a skirt that fills gaps between the horns so that the interface is a continuous interface between the sub zones.

The applicators of at least some of the rows may be offset laterally relative to the applicators of at least some of the other rows—i.e. laterally relative to the direction of movement of briquettes through the reduction zone.

The applicators of each row may be offset with respect to the applicators of successive rows.

When the applicators are horns, the horns may be pyramidal horns.

The pyramidal horns may include sectorial horns, each with one pair of opposing sides being flared and the other pair of opposing sides being parallel.

The sectoral horns in each row may be placed across the conveyor so that the shorter sides of rectangular openings of the sectoral horns are parallel with the direction of moment of the conveyor within the reduction furnace.

In other embodiments, at least some of the sectoral horns in each row may be placed across the conveyor so that the longer sides of rectangular openings of the sectoral horns are parallel with the direction of moment of the conveyor within the reduction furnace.

The conveyor may be movable in an endless path, with the conveyor returning to the feed zone of the furnace from the discharge zone of the furnace.

The conveyor may have residual heat as a result of passing through the furnace when it returns to the feed zone of the furnace.

The apparatus may be configured to generate a higher pressure of gas in the reduction zone compared to gas pressure in the preheat zone to cause gases generated in the reduction zone to flow counter-current to the direction of movement of briquettes on the conveyor through the furnace.

The apparatus may include a gas flow “choke” between the preheat zone and the reduction zone that contributes to generating the higher gas pressure for causing gases in the reduction zone to flow counter-current to the direction of movement of briquettes on the conveyor through the furnace.

The gas flow “choke” may be configured to increase the flow rate of the gas from the reduction zone to the preheat zone by a factor of 2-3 compared to what the flow rate would be without the gas flow “choke” in order to ensure that there is no substantial gas flow from the reduction zone to the preheat zone of the furnace.

The gas flow “choke” may be the result of forming the transverse cross-sectional area of the reduction zone to be less than the transverse cross-sectional area of the preheat zone.

The apparatus may include a flue gas outlet in the preheat zone for discharging gas produced in the furnace that flows in the counter-current direction to the outlet.

The apparatus may include an afterburning chamber for combusting combustible gas in the gas discharged via the flue gas outlet.

### BRIEF DESCRIPTION OF THE DRAWINGS

The present invention is described further by way of example with reference to the accompanying drawings of a linear hearth, of which:

FIG. 1 is (a) a schematic diagram of one embodiment of an apparatus for producing direct reduced iron (DRI) from briquettes of a composite of iron ore fragments and biomass in accordance with the invention, (b) a temperature profile along the length of a furnace of the apparatus for an embodiment of a method for producing direct reduced iron (DRI) from briquettes of a composite of iron ore fragments and biomass in accordance the invention, and (c) a plot of off-gas volumetric flow rate of gas produced along the length of the furnace during the course of the method; and

FIG. 2 is a flowsheet diagram illustrating one embodiment of a method for producing direct reduced iron (DRI) from briquettes of a composite of iron ore fragments and biomass in accordance the invention in the apparatus of FIG. 1; and

FIG. 3 is (a) a schematic diagram of a segment of a reduction zone of another, although not the only other, embodiment of the apparatus in accordance with the invention, showing two rows of horns, (b) is a theoretical static heating pattern showing the temperature profile of a bed of iron containing material passing under the horns shown in (a) as a result of heating via microwaves from the horns, and (c) is a theoretical dynamic heat pattern showing the temperature profile of the bed of iron containing material after having moved passed the two rows of horns.

### DESCRIPTION OF EMBODIMENTS

As noted above, in broad terms, the present invention is a method and an apparatus for continuously producing direct reduced iron (“DRI”) from iron ore and biomass, typically at least initially in the form of briquettes of a composite of iron ore fragments and biomass, that includes transporting iron ore and biomass through a furnace having an inlet for iron ore and biomass and an outlet for DRI and a feed zone, a preheat zone, a reduction zone, and a discharge zone between the inlet and the outlet.

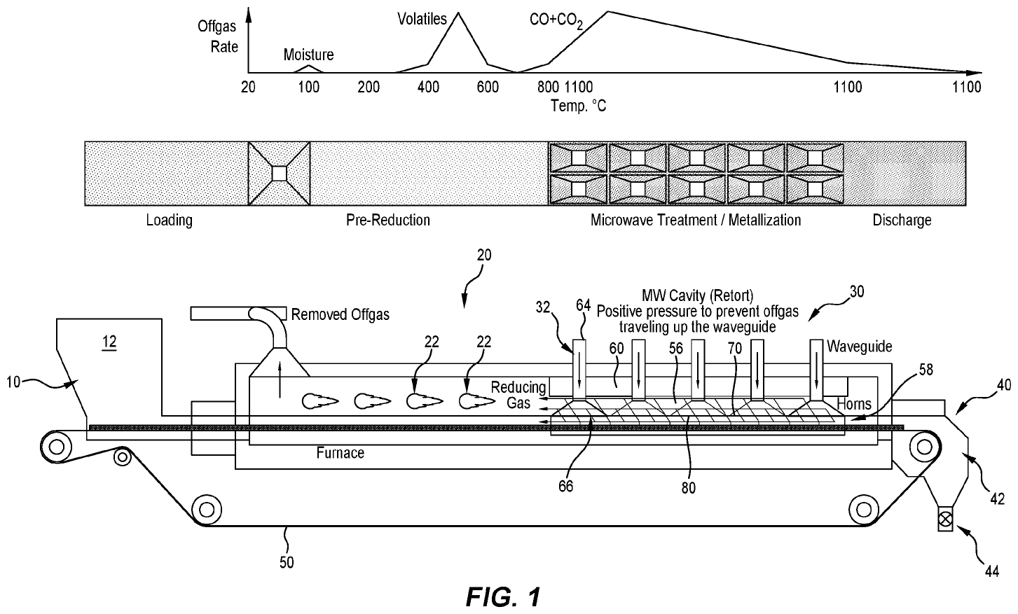

FIG. 1 is a schematic diagram of an embodiment of an apparatus of the present invention taken as a longitudinal section through a linear heath furnace.

As is described in more detail below, a key feature of the embodiments of the linear hearth furnace shown in the Figures is a plurality of applicators in the form of perforated horns in the Figures arranged in rows across a width of and along a section of a length of a reduction zone of the linear hearth furnace for supplying microwave energy into the reduction zone for heating briquettes in the described embodiments (or what remains of the material in the form of briquettes at this stage) passing through the reduction zone, the horns having outlet openings for microwave energy, at least substantially all of the horns within each row being arranged in a co-polarisation (same orientation) manner to form a regular field pattern, and with perforations of the perforated horns being configured to at least substantially prevent microwave energy passing upwardly through the perforations and to allow reaction gases generated by the material in the reduction zone to flow upwardly through the perforations. Allowing reaction gases to flow upwardly through the perforations means that there is a smaller volume of reaction gases in a space between the material and the horns that can flow from the reduction zone to the preheat zone and therefore a lower flow rate and less risk of entrainment of solid material (i.e. dust make) with the reaction gases. Modelling work of the applicant is based on keeping the flowrate below a threshold of 5 m/s. The actual threshold in any given situation may be a different flowrate.

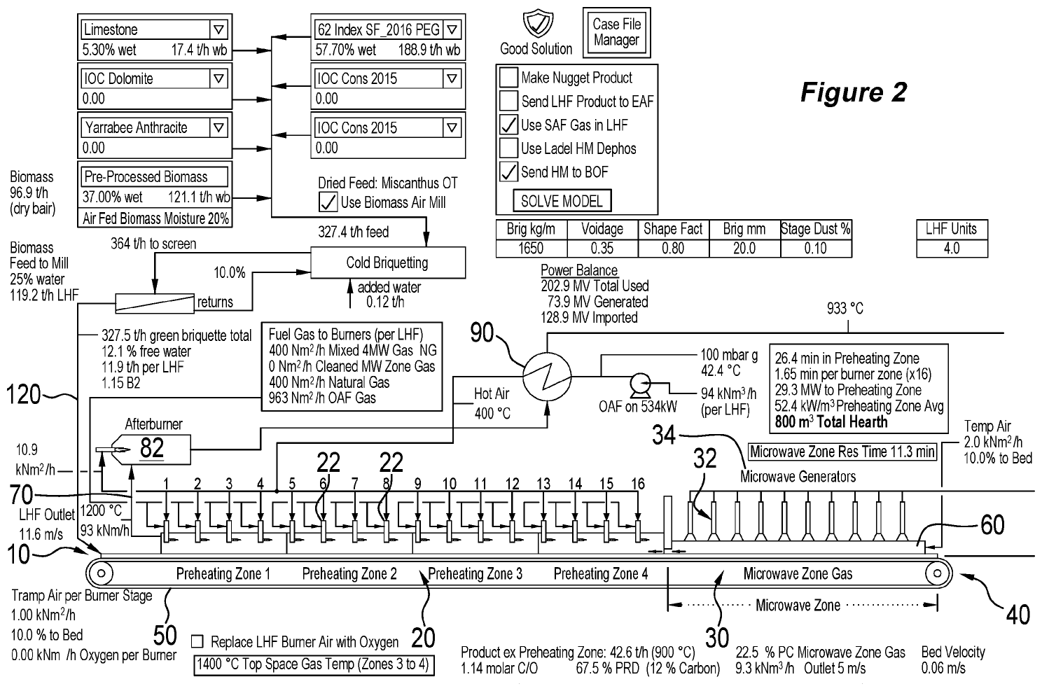

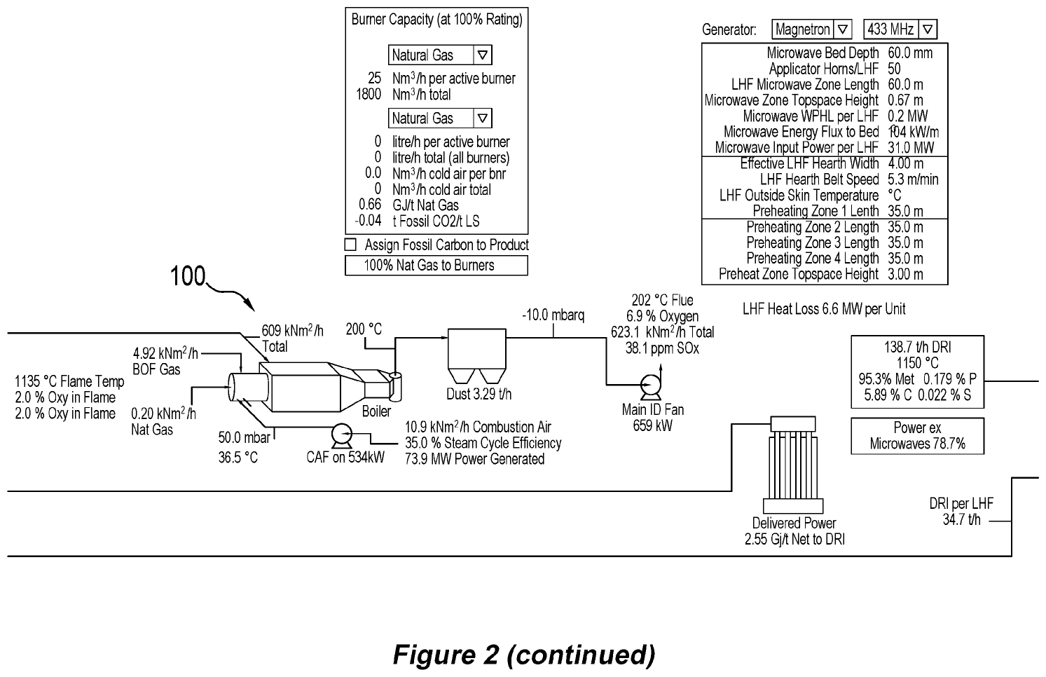

With reference to FIG. 1, the linear hearth furnace, generally identified by the numeral 3, includes an elongate refractory-lined chamber that has the following zones along its length:
(a) a feed zone 10 includes an inlet to the chamber and is configured to receive briquettes 120 (see FIG. 2) of iron ore and biomass, noting that the other embodiments of the invention are not based on the use of briquettes,
(b) a preheat zone 20 for heating material, i.e. iron ore and biomass, in the briquettes and reducing iron ore and releasing volatiles in biomass, with the volatiles being combusted in the preheat zone,
(c) a reduction zone 30 for heating material further and further reducing iron ore and forming DRI;
(d) a discharge zone 40 for DRI that includes an outlet of the chamber;
(e) an endless conveyor 50 having a refractory or metallic material base that moves through the chamber from the inlet to the outlet and transports material that is at least initially in the form of briquettes through the chamber from the inlet and discharges DRI from the outlet and then returns to the inlet to be re-loaded with additional briquettes; and
(f) a flue gas outlet 70 in the preheat zone 20 for discharging gas produced in the furnace by heating and/or combustion within the furnace.

The feed zone 10 is configured to continuously feed briquettes 120 into the feed zone 10 via the inlet to form a relatively uniform bed of briquettes on the moving conveyor 50 in the feed zone 10 of the chamber, while restricting outflow of furnace gases via the inlet. The feed zone 10 includes a feed chute 12 that can receive and direct briquettes 120 onto the conveyor 50.

The term “relatively uniform bed of briquettes” is understood herein to mean a relatively uniform layer of briquettes covering the base and typically having a consistent ‘bed’ depth, at least length ways, i.e., in the direction of briquette travel within the furnace. This does not however mean that individual briquettes have to be stacked in anything more than a random way on the base, noting that in some embodiments this may be desirable.

The discharge zone 40 is configured to continuously discharge DRI from the discharge zone 40 via the outlet, while restricting the inflow of oxygen-containing gases into the reduction zone 30 of the chamber. The discharge zone 40 includes an enclosed discharge chute 42 that has a downwardly directed opening that has a flow control valve 44 that can be selectively operated to allow DRI to flow through the opening.

The preheat zone 20 has a plurality of air or oxygen-enriched air fed burners 22 for generating heat by burning combustible gases in a top space of the preheat zone 20. The burners 22 are spaced along the length of the preheat zone 20. The optimal spacing can be readily determined by a skilled person for any given operating conditions, such as the amount and type of biomass and the amount and type of iron ore and the required metallisation.

The combustible gases generated in the furnace include combustible gases originating within the furnace. The combustible gases include:
(a) volatiles in biomass in material moving through the preheat zone 20; and
(b) combustible gases, such as CO, generated by reduction of iron ore in material in:
   (i) the preheat zone 20 and
   (ii) the reduction zone 30, with the combustible gases generated in the reduction zone 30 flowing from the reduction zone 30 to the preheat zone 20, as described further below.

There may be additional combustible gases supplied to the burners 22 depending on the operating conditions in the furnace.

In use, the reduction zone 30 is an anoxic environment.

The reduction zone 30 includes a plurality of microwave energy input units 32 (waveguides 64 and horns 66) in a top space thereof for heating briquettes. The microwave energy input units 32 are operatively connected to a microwave energy generator 34 (see FIG. 2—in which the generator is a microwave energy generator).

The horns 66 form an interface 80 that separates the reduction zone 30 into an upper sub zone 56 and a lower sub zone 58.

The horns 66 are pyramidal horns, more particularly sectoral horns 66 in the embodiment shown in the Figures.

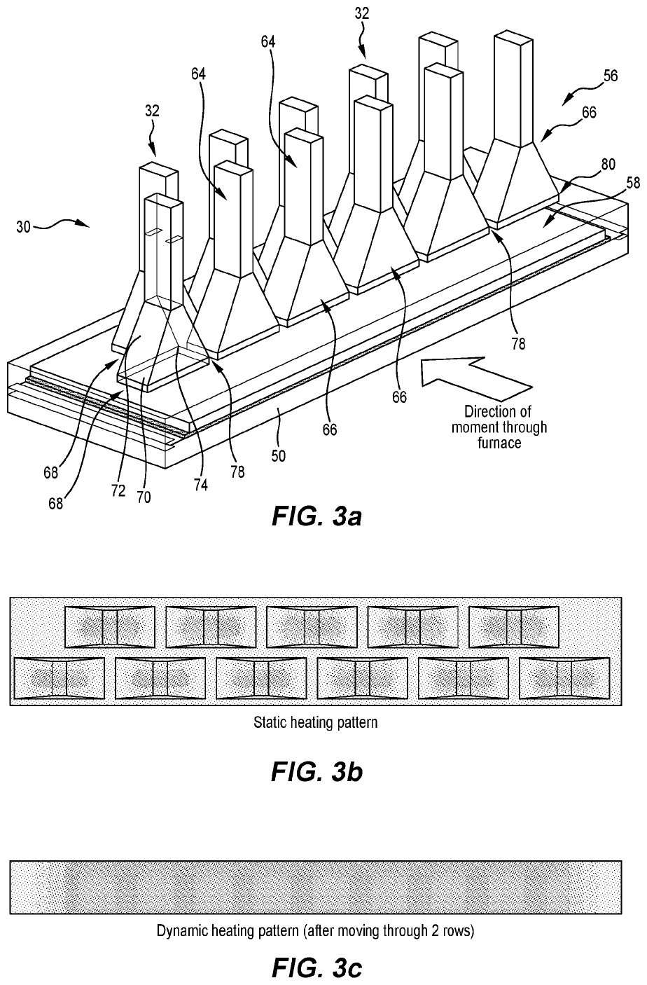

The horns 66 are arranged in rows 68 (see FIG. 3(a) which shows two rows only) having microwave outlets 70 for microwave energy. The rows 68 extend across a width of a section of the reduction zone 30 and along a length of the section above a top surface of the conveyor 50 and, in use above a top surface of briquettes carried on the conveyor 50. The section may be any suitable length and any suitable width.

The horns 66 are in contact with each other at the microwave outlets 70 of the horns 66.

Therefore, at this location, the interface 80 is a continuous interface, i.e. with no gaps between the horns 66 at this location.

The interface 80 is shown as a horizontal line in FIG. 1. This indicates that there is a sharp transition between the upper sub zone 56 and the lower sub zone 58. It is noted that the invention is not confined to a sharp transition.

The horns 66 are defined by side walls 72, 74 that are typically formed from sheet material.

The horns 66 are rectangular in transverse section and are formed with only one pair of opposing side walls 72 being flared and diverging with distance from the waveguides 64 and the other pair of opposing sides 74 being parallel to each other which, in use, produces a fan-shaped beam, which is narrow in the plane of the flared side walls, but wide in the plane of the narrow side walls.

The flaring may be in the E-plane (electric field) or H-plane (magnetic field) direction to form a rectangular opening at its output end.

The horns 66 in each row are placed across the conveyor 50 so that the shorter sides of the rectangular microwave outlets 70 of the sectoral horns 66 are parallel with the direction of moment of the conveyor 50 within the reduction zone 30.

The horns 66 are arranged and configured so that the cumulative effect of the field patterns of the horns is to maximise the homogeneity of treatment of the material on the conveyor 50—see FIG. 3(c) where this is illustrated by the uniform temperature profile of material that have passed through the reduction zone 30.

The horns 66 within each row 68 are arranged in a co-polarisation (same orientation) manner to form a regular, typically highly uniform, field pattern, and with the horns in at least some of the rows 68 being offset laterally in relation to the horns of at least one of the other rows 68. FIG. 3(a) shows an embodiment of an off-set arrangement. This is not the only possible embodiment.

The side walls 72, 74 of the horns 66 have a plurality of perforations (not shown), for example in the form of holes or slots, punched/cut through the side walls.

The perforations are configured to allow reduction gases from the lower sub zone 58 and to at least substantially prevent microwave energy from passing from the lower sub zone 58 into the upper sub zone 56.

The term “at least substantially prevent” is a recognition that it is extremely difficult to prevent all microwave energy from passing from the lower sub zone 58 into the upper sub zone 56.

The arrangement and the size of the perforations will in part be determined by the wavelength of the microwave energy and the thickness and material of the side walls 72, 74 of the horns. The perforations may be of any size and/or shape but must be selected to prevent microwaves from passing through the perforations while not unduly restricting reaction gases passing therethrough.

In use of the apparatus, gases generated in the reduction zone 30 flow into the preheat zone 20 counter-current to the direction of movement of briquettes on the conveyor 50 through the furnace from the inlet to the outlet.

The counter-current flow of gas from the reduction zone 30 into the preheat zone 20 is caused by a higher gas pressure in the reduction zone 30 compared to gas pressure in the preheat zone 20. While such pressure effect will be largely caused by the suction effect of a required exhaust fan linked to a dust extraction (baghouse) system at the atmosphere discharge end of the process the higher gas pressure is also the result of several structural and operational factors in the described embodiments of the method and the apparatus of the invention.

One factor is that the transverse cross-sectional area of the reduction zone 30 is less than that of the preheat zone 20. In this regard, the reduction zone 30 includes an additional elongate upper wall section 60.

Another factor is injecting nitrogen gas (or any other suitable gas) into the reduction zone 30 to contribute to generating and maintaining the higher pressure in the zone (and the anoxic environment).

Another factor is the volume of gas generated via reduction of iron ore in the reduction zone 30. This reduction gas contributes to generating and maintaining the higher pressure in the zone (and the anoxic environment).

The volume of reduction gas generated in the reduction zone 30 is illustrated by the plot of off-gas volumetric flow rate shown in FIG. 1.

A final factor is the induced draft fan at the end of the off-gas train (see FIG. 2); which depending on its size may have a significant influence.

The counter-current flow of gas from the reduction zone 30 to the preheat zone 20 transfers combustible gases, such as CO, that are generated in reactions that reduce iron ore in the reduction zone 30 to the preheat zone 20. The combustible gases in the gas flow from the reduction zone 30 are combusted by the plurality of air or oxygen-enriched air fed burners 22 spaced along the length of the preheat zone 20. The combustion profile may be 35-45% at a hot end of the preheat zone 20, i.e., at the end adjacent the reduction zone 30, increasing to 90-95% at a cold end of the preheat zone 20, i.e. at the end adjacent the feed zone 10.

The combustion of (a) combustible gases generated in the reduction zone 30, (b) combustion of volatiles released from biomass in the preheat zone, and (c) combustion of combustible gases generated by reduction of iron ore in the preheat zone 20 provides an important component of the heat requirements for the method.

The temperature profile shown in FIG. 1 is an example of a suitable temperature profile along the length of the furnace.

In use, the conveyor 50 transports material that is initially in the form of briquettes (not shown) of iron ore and biomass successively and continuously through the zones 10, 20, 30, 40 in a sequential manner and eventually circles back in its endless path so that each portion of the refractory or metallic base material of the conveyor 50 eventually presents itself at the feed zone 10 to be loaded with more briquettes. Preferably, the refractory or metallic base material has residual heat from the chamber when the conveyor 50 returns to the feed zone 10.

In use, gases generated in the chamber are discharged as a flue gas via the flue gas outlet 70 in the preheat zone 20.

As described above in relation to the term “briquettes”, it is important for the invention that iron ore fragments and biomass be in quite close contact. Any approach to achieving this close contact may be used. Ore-biomass mixing followed by compaction of the materials to form briquettes between two rolls in which there are naturally aligning pockets, is one example. Alternative such compaction option is ore-biomass mixing followed by roll pressing using rolls without pockets into compressed slabs containing the iron ore fragments and biomass that break up naturally (or are deliberately broken up) prior to feeding into the feed station zone.

The briquettes may be manufactured by any suitable method. By way of example, measured amounts of iron ore fines and biomass and water (which may be at least partially present as moisture in the biomass) and optionally flux is charged into a suitable size mixing drum (not shown) and the drum rotated to form a homogeneous mixture. Thereafter, the mixture may be transferred to a suitable briquette-making apparatus (not shown) and cold-formed into briquettes.

In one embodiment of the invention, the briquettes are roughly 20 cm³ in volume and contain 30-40% biomass (e.g., elephant grass at 20% moisture). A small amount of flux material (such as limestone) may be included, with the balance comprising iron ore fines.

The physical structure of the DRI at the end of the process is not critical. The physical structure may be friable and break easily or it could resemble a robust 3D “chocolate bar”.

Either way, with further reference to FIG. 1, the DRI is fed into an insulated vessel (not shown) which is configured to transport the DRI (hot) to a downstream electric melting furnace (not shown). Here a feed system (not shown) can accept the hot DRI from the vessel and pass the DRI through a system of (for example) pushers and breaker bars (not shown) in order to feed the DRI into the electric melting furnace, including any furnace bath, for the production of steel.

It is noted that those structural components that are not specifically shown in FIG. 1 are generally standard components within the iron industry and the skilled person would be able to make an appropriate selection of the components.

FIG. 2 is a process flowsheet diagram illustrating one embodiment of a method for producing direct reduced iron (DRI) according to the invention from cold-formed briquettes of iron ore and biomass in the furnace of FIG. 1.

The data in the diagram of FIG. 2 is derived from a model developed by the applicant and illustrates an embodiment of the method.

With further reference to FIG. 2, in the described embodiment based on a linear hearth furnace arrangement as shown in FIG. 1, cold-formed briquettes are continuously feed onto a conveyor travelling at around 5 m/min. that has a refractory or metallic base that presents to the briquettes through a feeding device (not shown) to create a bed depth of around 60 mm and to deliver around 80 tonnes per hour of briquettes into the furnace. The effective width of the base for receiving briquettes is four (4) metres.

The briquettes comprise 37% elephant grass at 20% water, 5% limestone and 58% Pilbara Blend iron ore fines.

The length of the preheat zone 20 is 140 metres and is divided into 4 sections for ease of processing controls.

The length of the reduction zone 30 is 60 metres with 50 microwave energy input units 32 extending downwardly into the top space thereof.

A gas flow restriction is created between the two zones through the use of the baffle wall 60 that changes the top space heights between the two zones, with the top space height and the overall transverse cross-sectional area of the reduction zone 30 being less than that of the preheat zone 20.

In the FIG. 2 embodiment, gas flowing from the reduction zone 30 to the preheat zone 20 has been combusted to a post combustion degree of around 10-30% in the reduction zone, depending on the amount of ingress air into the reduction zone 30, such as from the discharge zone 40. Therefore, there is considerable combustible gas in this gas.

In the FIG. 2 embodiment, the amount of gas flowing from the reduction zone 30 to the preheat zone 20 is around 200-300 Nm³/tonne of DRI discharged from the furnace, and the gas velocity at the interface between the reduction zone 30 and the preheat zone 20 is around 4-10 m/s (nominally 5 m/s).

As described in relation to FIG. 1, the gas flows into and along the preheat zone 20, counter-current to the movement of briquettes, and the gas is subjected to incremental combustion as it passes through the plurality of air or oxygen-enriched air fed burners 22 which, in this embodiment, receive preheated (and/or oxy-enriched) air.

The post-combustion profile in the preheat zone 20 is typically 35-45% at the hot end (i.e., the reduction zone 30 end), increasing gradually to around 90-95% at the flue gas outlet 70 end. The preheat zone top space is therefore maintained in a bulk reducing condition all the way along its length in the embodiment, with feed oxygen being consumed rapidly in the vicinity of each burner 22 (in a small, localised region).

Off-gas at the flue gas outlet 70 end is then ducted (hot, around 1100-1300° C.) to an afterburning chamber 82, where final combustion of combustible gas in the gas is performed.

The gas from the afterburning chamber 82 is then used (in the example provided) to preheat air for the burners 22 in the preheat zone 20 via a heat exchanger 90, before passing to a boiler 100 for final heat recovery and then discharge as flue gases to the atmosphere.

This example necessarily contains multiple assumptions regarding kinetic parameters—precise details may shift as a result of different kinetics. However, the principles are not expected to change. Although the current example is based on preheated air, additional oxygen could be added to the air mixture prior to heating so that the ratio of air to oxygen could be varied as an additional control parameter to further optimise the process.

FIG. 3(a) is a schematic of the inside of a segment of the reduction zone 30 of a linear hearth furnace of one embodiment of an apparatus in accordance with the invention.

FIG. 3(a) shows two rows 68 of off-set sectoral horns 66, each row placed above and extending across a top surface of a conveyor 50 so that the shorter sides 72 of the microwave outlets 70 of the horns are parallel with and the longer sides 74 of the microwave outlets 70 are perpendicular to the direction of moment of the conveyor within the linear hearth furnace.

FIG. 3(a) also shows an interface 80 that separates the reduction zone 30 into an upper sub zone 56 and a lower sub zone 58. There are small gaps 76 between the horns 66 in each row 68 and there is a small gap 78 between the rows 68 at the level of the microwave outlets 70.

Whilst not shown in the Figure, these small gaps 76, 78 are closed by a microwave energy barrier that is configured to allow reduction gases to pass therethrough and to at least substantially prevent microwave energy passing therethrough.

The microwave energy barrier may be in the form of perforated metal elements that are connected to the horns 66 close to the microwave outlets 70. The end result is that the interface 80 comprises the horns 66 and the microwave energy barrier in the gaps, and the interface 80 is a single continuous interface at this height of the reduction zone 30.

FIG. 3(b) is the theoretical temperature profile of a bed of iron containing material that receives microwaves under such a horn structure (i.e., as a static heating pattern without the conveyor moving).

FIG. 3(c) is the theoretical temperature profile of the same bed of iron containing material having moved on the conveyor past the two rows of horns.

Many modifications may be made to the embodiments described above without departing from the spirit and scope of the invention.

By way of example, whilst the embodiment shown in FIG. 2 includes an 80 tonnes per hour briquette fed furnace that is 4 m wide by 200 m long (with a bed depth of 60 mm), with the briquettes comprising 38% elephant grass at 20% water, 5% limestone and 57% Pilbara Blend iron ore fines, it can readily be appreciated the invention is not confined to this size briquette bed with this composition of the briquettes.

By way of further example, whilst the conveyor 50 in the embodiment shown in FIG. 2 has a refractory or metallic material base, the invention is not limited to this arrangement and extends to any suitable conveyor.

By way of further example, whilst the embodiment shown in FIG. 2 includes the use of nitrogen gas injection to generate and maintain the anoxic environment in the reduction zone, the invention is not limited to this particular gas.

In addition, the invention is not confined to such gas injection at all if the gas generated via reduction of iron ore in the reduction zone 30 is sufficient to maintain the required anoxic environment.

By way of further example, whilst the above embodiment includes continuous operation, the invention is not so limited.

By way of further example, whilst the embodiments shown in the Figures include feed material in the form of briquettes of iron ore and biomass, the invention is not so limited and extends to other forms of the material. For example, the material may be a bed of iron ore and biomass. Specifically, the invention is not confined iron ore and biomass being supplied to a heath furnace as briquettes.

### REFERENCES

1. Vogl, V et al, Assessment of hydrogen direct reduction for fossil-free steelmaking, Journal of Cleaner production 203 (218) 736-745
2. Strezov, V, Iron ore reduction using sawdust: experimental analysis and kinetic modelling, renewable Energy 31(12) 1892-1905, October 2006

1. A method for producing direct reduced iron (DRI) from iron ore using biomass (as a source of reductant) and microwave energy (as a heat source) in a hearth furnace having a preheat zone and a reduction zone, the method including moving a conveyor carrying a material including iron ore and biomass successively through the preheat zone and the reduction zone in a direction from an inlet to an outlet and heating and progressively reducing iron ore and discharging DRI from the outlet, allowing reduction gases including combustible gases produced by heating material and by reduction of iron ore to flow in an opposite direction to that of the conveyor, combusting combustible gases in the reduction gases via air or oxygen-enriched air fed burners in the preheat zone, maintaining an anoxic atmosphere in the reduction zone, supplying microwave energy to facilitate heating material and reduction of iron ore in the anoxic atmosphere in the reduction zone, with the microwave energy being delivered directly onto material on the conveyor via a plurality of microwave applicators having microwave outlets in a chamber of the reduction zone with the applicators being arranged in a plurality of rows of applicators extending across a width of and along a section of a length of the reduction zone with the microwave outlets being spaced above but in close proximity to the material on the conveyor, with the reduction zone including a lower sub zone and an upper sub zone separated by an interface, with the interface being configured to so that (a) microwave energy is at least substantially prevented from passing through the interface to the upper sub zone, and (b) reduction gases produced in the lower sub zone from reduction of iron ore can flow through the interface into the upper sub zone.

2.-15. (canceled)

16. The method defined in claim 1 includes supplying microwave energy to the plurality of rows of applicators to create a uniform, regular heating pattern for material on the conveyor.

17.-21. (canceled)

22. The method defined in claim 1 includes controlling the method so that at least 90% of volatiles in biomass in the material are released as a gas in the preheat zone.

23. The method defined in claim 1 includes controlling generating a higher pressure of gases in the reduction zone compared to gas pressure in the preheat zone and thereby causing gases generated in the reduction zone to flow counter-current to the direction of movement of material on the conveyor through the furnace.

24. A method for producing direct reduced iron (DRI) from iron ore using biomass (as a source of reductant) and microwave energy (as a heating source) in a hearth furnace, the method including counter-current movement of (a) a material, the material including iron ore and biomass, the material at least initially being in the form of briquettes of iron ore and biomass, successively through a preheat zone and a reduction zone in a direction from an inlet (the inlet end) to an outlet (the outlet end) and discharging DRI from the outlet and (b) a flow of combustible gases produced by heating material and reduction of iron ore in the material in the reduction zone to the preheat zone (at the inlet end), combusting combustible gases arising from such heating of biomass and reduction of iron ore by air or oxygen-enriched air fed burners in the preheat zone, maintaining an anoxic atmosphere in the reduction zone, supplying microwave energy to facilitate reduction of iron-containing material in the anoxic atmosphere, with the microwave energy being delivered via a plurality of microwave applicators in the form of horns into a lower sub zone of the reduction zone directly onto the material below the horns, with the horns having perforations that enable reduction gases arising from such reduction to pass therethrough while is at least substantially preventing microwave energy from passing therethrough, thereby allowing the reduction gases to be sufficiently unrestricted by the horns so that reduction gases can flow into an upper sub zone of the reduction zone so that reduction gas flowing from the reduction zone to the preheat zone does not exceed a threshold bulk gas velocity.

25. The method defined in claim 24 wherein the threshold bulk gas velocity is 5 m/sec.

26. An apparatus for producing direct reduced iron (DRI) from iron ore fragments and biomass, the apparatus including a furnace that includes a chamber having:
(a) an inlet for a material including iron ore and biomass at one end and an outlet for direct reduced iron at the other end,
(b) the following zones:
(i) a feed zone that includes the inlet,
(ii) a preheat zone for heating the material and reducing iron ore in the material and releasing volatiles in biomass in the material, the preheat zone including a plurality of air or oxygen-enriched air fed burners for generating heat by burning combustible gases in a top space of the preheat zone, with the combustible gases including combustible gases originating within the furnace,
(iii) a reduction zone for heating material and reducing iron ore in the material and forming DRI, the reduction zone including an upper sub zone and a lower sub zone and an interface separating the subzones that is configured to so that (a) microwave energy is at least substantially prevented from passing through the interface to the upper sub zone and (b) reduction gases produced in the lower sub zone from reduction of iron ore can flow through the interface into the upper sub zone, a plurality of applicators arranged in rows across a width of and along a section of a length of the reduction zone for supplying microwave energy into the lower sub zone for heating the material in the lower sub zone, the applicators having outlet openings for microwave energy, at least substantially all of the applicators in each row being configured so that microwave energy forms a regular field pattern; and
(iv) a discharge zone that includes the outlet; and
(c) a conveyor for receiving and transporting the material through the zones from the inlet to the outlet.

27. The apparatus defined in claim 26 wherein the interface is a sharp transition between the two sub zones.

28. The apparatus defined in claim 26 wherein the interface is a gradual change over a section of the height of the reduction zone.

29. The apparatus defined in claim 26 wherein the interface includes the applicators.

30. The apparatus defined in claim 29 wherein the applicators are horns.

31. The apparatus defined in claim 30 wherein the horns are perforated horns with perforations that are configured to allow reduction gases and at least substantially no microwave energy to pass therethrough.

32. The apparatus defined in claim 29 wherein the applicators in each row and in successive rows of applicators along the length of the section of the reduction zone are in contact with each other so that the interface is a continuous interface between the sub zones.

33. The apparatus defined in claim 26 wherein the rows of applicators are spaced apart along the length of the section of the length of the reduction zone so that there are gaps between the successive rows.

34. The apparatus defined in claim 26 wherein the applicators in at least some of the rows are spaced apart so that there are gaps between the applicators.

35. The apparatus defined in claim 33 wherein the interface includes a microwave energy barrier in gaps between the applicators that is configured to allow reduction gases to pass therethrough and to at least substantially prevent microwave energy passing therethrough.

36.-37. (canceled)

38. The apparatus defined in claim 26 wherein the applicators of at least some of the rows are offset laterally relative to the horns of at least some of the other rows—i.e. laterally relative to the direction of movement of briquettes through the reduction zone.

39. The apparatus defined in claim 38 wherein the horns of each row are offset with respect to the applicators of successive rows.

40. The apparatus defined in claim 30 wherein the horns are pyramidal horns.

41. The apparatus defined in claim 40 wherein the pyramidal horns include sectorial horns, each with one pair of opposing sides being flared and the other pair of opposing sides being parallel.

42. (canceled)
